(19) United States
(12) Patent Application Publication
(10) Pub. No.: US 2017/0061377 A1
(43) Pub. Date: Mar. 2, 2017

(54) EDUCATIONAL INSTITUTION HIERARCHY

(71) Applicant: LinkedIn Corporation, Mountain View, CA (US)

(72) Inventors: Kathy Hwang, Mountain View, CA (US); Navneet Kapur, Sunnyvale, CA (US); Wenyu Huo, Mountain View, CA (US); Fangyi Luo, Mountain View, CA (US); Gloria Lau, Los Gatos, CA (US); Daniel Duckworth, Mountain View, CA (US); Qifan Hu, Mountain View, CA (US)

(21) Appl. No.: 14/834,046

(22) Filed: Aug. 24, 2015

(51) Int. Cl. G06Q 10/10; G06Q 50/00; G06Q 50/20

(52) U.S. Cl. CPC G06Q 10/10; G06Q 50/205; G06Q 50/01

(57) ABSTRACT

Techniques for managing information describing a hierarchy of relationships between educational institutions are described. According to various embodiments, first feature data describing a first school and second feature data describing a second school is accessed via one or more databases. A confidence score is then generated based on a machine learned model, the first feature data and the second feature data, the confidence score indicating a probability that the second school is a sub-school of the first school. Thereafter, based on a comparison of the confidence score to a threshold, is it is determined that the second school is a sub-school of the first school. Hierarchy information identifying a hierarchy of relationships between a plurality of schools is then generated or modified, the hierarchy information indicating that the second school is a sub-school of the first school.

### TECHNICAL FIELD

The present application relates generally to data processing systems and, in one specific example, to techniques for managing information describing a hierarchy of relationships between educational institutions.

### BACKGROUND

Online social network services such as LinkedIn® are becoming increasingly popular, with many such websites boasting millions of active members. Each member of the online social network service is able to upload an editable member profile page to the online social network service. The member profile page may include various information about the member, such as the member's biographical information, photographs of the member, and information describing the member's employment history, education history, skills, experience, activities, and the like. Such member profile pages of the networking website are viewable by, for example, other members of the online social network service.

Moreover, the LinkedIn® online social network service also provides educational institution pages (also known was “university pages” or “school pages”) associated with different educational institutions, where each page includes various information about each educational institution, such as news, photos, updates posted by school administrators, information regarding notable alumni, etc.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a flowchart illustrating an example method, according to various embodiments;

FIG. 4 illustrates an example portion of a data structure containing hierarchy information, according to various embodiments;

FIG. 5 is a flowchart illustrating an example method, according to various embodiments;

FIG. 6 is a flowchart illustrating an example method, according to various embodiments;

FIG. 7 is a flowchart illustrating an example method, according to various embodiments;

FIG. 8 illustrates an example portion of a user interface displaying a school webpage, according to various embodiments;

FIG. 9 is a flowchart illustrating an example method, according to various embodiments;

FIG. 10 is a flowchart illustrating an example method, according to various embodiments;

FIG. 11 illustrates an example mobile device, according to various embodiments; and

FIG. 12 is a diagrammatic representation of a machine in the example form of a computer system within which a set of instructions, for causing the machine to perform any one or more of the methodologies discussed herein, may be executed.

### DETAILED DESCRIPTION

Example methods and systems for managing information describing a hierarchy of relationships between educational institutions are described. In the following description, for purposes of explanation, numerous specific details are set forth in order to provide a thorough understanding of example embodiments. It will be evident, however, to one skilled in the art that the embodiments of the present disclosure may be practiced without these specific details.

According to various embodiments, a system is configured to generate and manage educational institution hierarchy information (also referred to herein as university hierarchy information or school hierarchy information) that describes the hierarchical relationships between educational institutions, such as educational institutions with profiles on an online social networking service such as LinkedIn®. For example, several schools have grown so large and prestigious that their departments are now recognized as independent institutions. Examples include U.C. Berkeley's Haas School of Business, Stanford Law School, or MIT's Sloan School of Management. While more or less distinct from their parent institution, the relationship these schools share with their parents is nonetheless valuable to recognize. Thus, the system described herein is configured to discover and expose these Parent-Child school relationships.

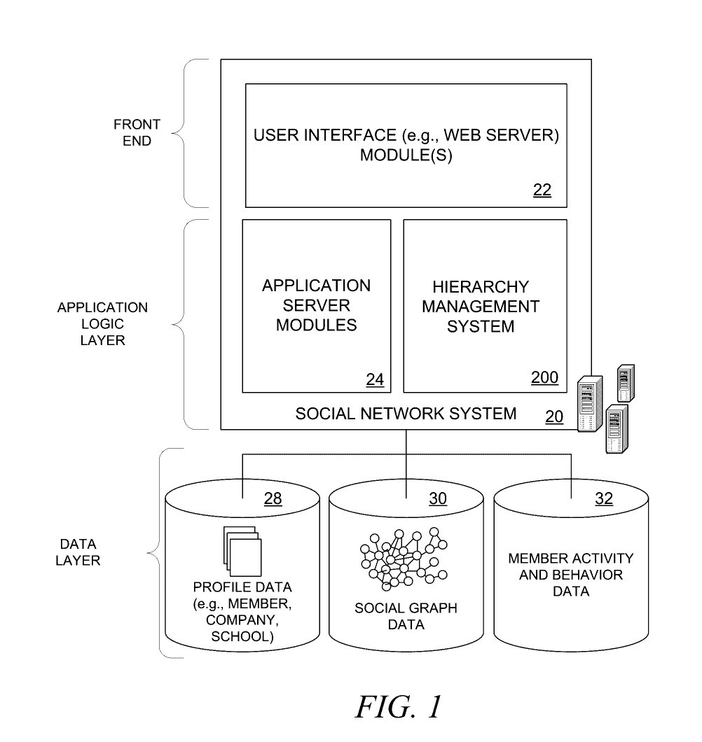

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

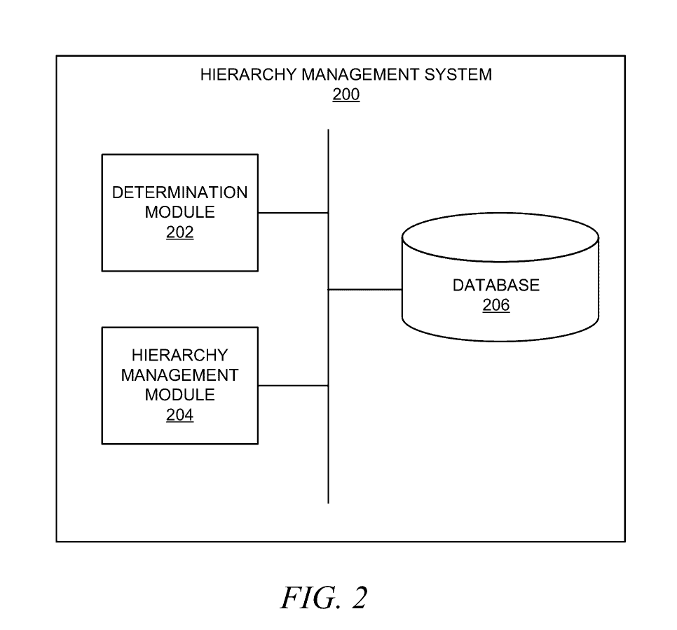

With some embodiments, the social network system 20 includes what is generally referred to herein as a hierarchy management system 200. The hierarchy management system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, a hierarchy management system 200 includes a determination module 202, a hierarchy management module 204, and a database 206. The modules of the hierarchy management system 200 may be implemented on or executed by a single device such as a school hierarchy management device, or on separate devices interconnected via a network. The aforementioned school hierarchy management device may be, for example, one or more client machines or application servers. The operation of each of the aforementioned modules of the hierarchy management system 200 will now be described in greater detail in conjunction with the various figures.

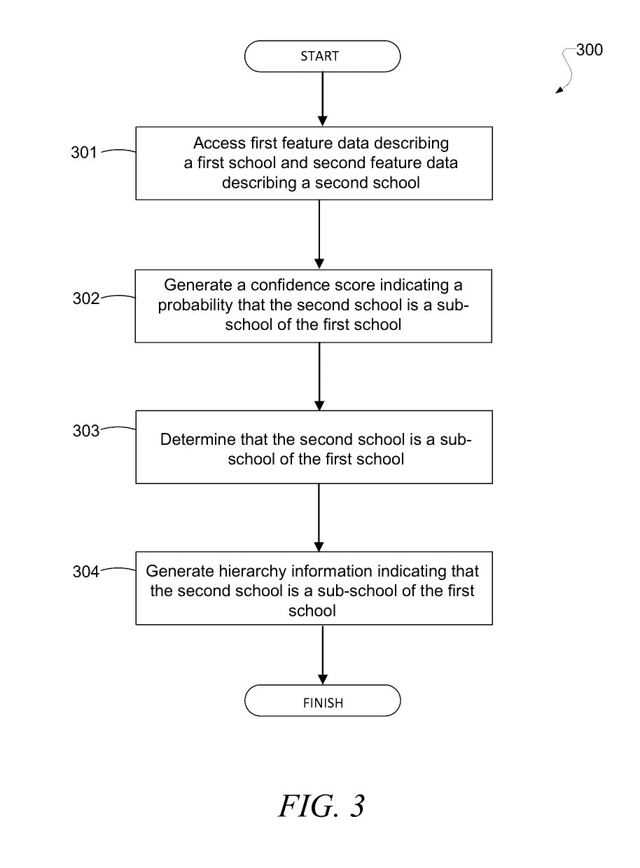

FIG. 3 is a flowchart illustrating an example method 300 for generating or modifying hierarchy information, consistent with various embodiments described herein. The method 300 may be performed at least in part by, for example, the hierarchy management system 200 illustrated in FIG. 2 (or an apparatus having similar modules, such as one or more client machines or application servers). In operation 301, the determination module 202 accesses, via one or more databases, first feature data describing a first school and second feature data describing a second school. In some embodiments, the first feature data and the second feature data describes a name, uniform resource locator (URL), and location of the first school and the second school, respectively.

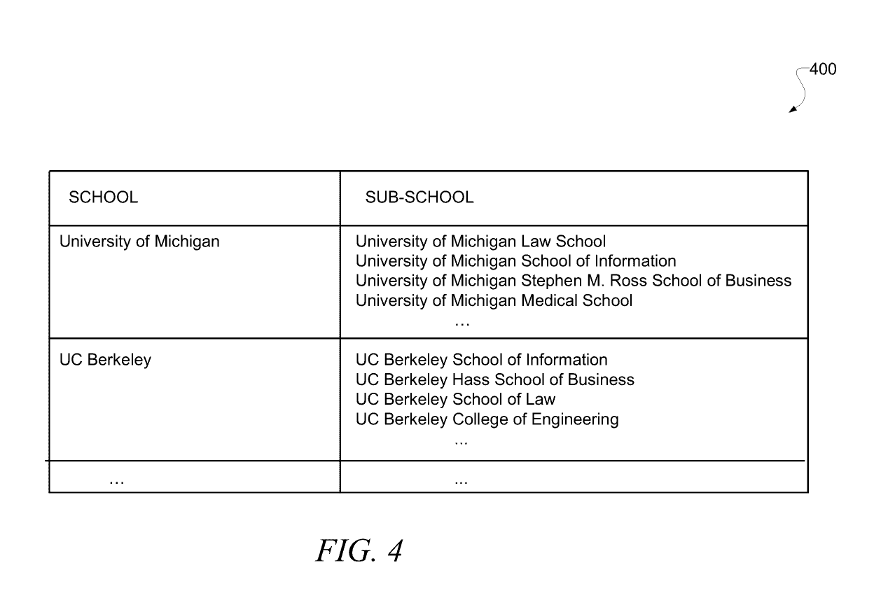

In operation 302, the determination module 202 generates generating a confidence score indicating a probability that the second school is a sub-school of the first school using a machine learned model, the first feature data and the second feature data accessed in operation 301 being inputs to the machine learned model. The generation of this confidence score is described in more detail below. In operation 303, the hierarchy management module 204 determines, based on a comparison of the confidence score generated in operation 302 to a threshold, that the second school is a sub-school of the first school (e.g., when the confidence score is greater than a predetermined threshold). In operation 304, the hierarchy management module 204 generates or modifies hierarchy information identifying a hierarchy of relationships between a plurality of schools, so that the hierarchy information indicates that the second school is a sub-school of the first school. For example, FIG. 4 illustrates example hierarchy information 400 indicating schools and related sub-schools. Such hierarchy information may include data records or data fields that are included in a data table or a data structure that is stored in a database (e.g., database 206 in FIG. 2) or some other storage device. It is contemplated that the operations of method 300 may incorporate any of the other features disclosed herein. Various operations in the method 300 may be omitted or rearranged. While the example in FIG. 4 illustrates schools and associated sub-schools, it is understood that each of the sub-schools may themselves have sub-schools of their own, and thus the hierarchy information may correspond to a “tree” like data structure, with parent schools, child schools that are sub-schools of the parent schools, grandchildren schools that are sub-schools of the child schools, and so on. Moreover, in some embodiments, it is possible for a school to be a child of multiple schools (e.g., a joint venture).

As described above, in operation 302, the determination module 202 generates a confidence score indicating a probability that a school B is a sub-school of a school A (or, put another way, that school A is a parent of school B). In some embodiments, the determination module 202 generates this confidence score by applying feature data of school A and school B to a trained machine learned model (e.g., a Logistic Regression-based machine learning model) that is configured to predict, based on feature data of school A and school B, the likelihood that school A is a parent of school B. For example, the determination module 202 may access various information about school A and school B, including a name, uniform resource locator (URL), and location of the first school and the second school, respectively, and generate the following “school feature data” for insertion into a feature vector: whether school A's name is a substring of school B's name; name edit distance between A and B's name, normalized to some threshold number (e.g., 0.1); whether the URL associated with school B's is a substring of the URL associated with school A; whether school B's city information available; whether school A and B are in the same state; whether school A and B are in the same country; whether school B's name matches (schoolκollege) of (law|medicinelmanagement|businesslinformation) OR medical center OR (law|medical|business) school; and whether school A and B's name are exactly the same. In some embodiments, each of the above features may be represented by a single position or feature data point in a feature vector (e.g., where Yes may be represented by 1 at the appropriate position in the feature vector, and No may be represented by 0 at the appropriate position in the feature vector). In some alternative embodiments, each feature is expanded into three feature data points, indicating yes, no, or insufficient data to tell (with a 1 at the feature data point indicating that corresponding condition is true, a 0 at the appropriate feature data point indicating that corresponding condition is false), such that there are 24 total features. In some embodiments, the machine learned model (e.g., the coefficients/weights thereof) may be trained based on multiple examples of positive training feature data (e.g., the school feature data described above) of two schools known to be related, and multiple examples of negative training feature data (e.g., the school feature data described above) of two schools known not to be related. By applying the features of school A and school B to the trained machine learned model, the trained machine learned model can output a confidence score indicating a probability that school B is a sub-school of school A. In some embodiments, the model is a vector of weights for each feature and the confidence score may be a dot product of the feature vector and the vector of weights (the model).

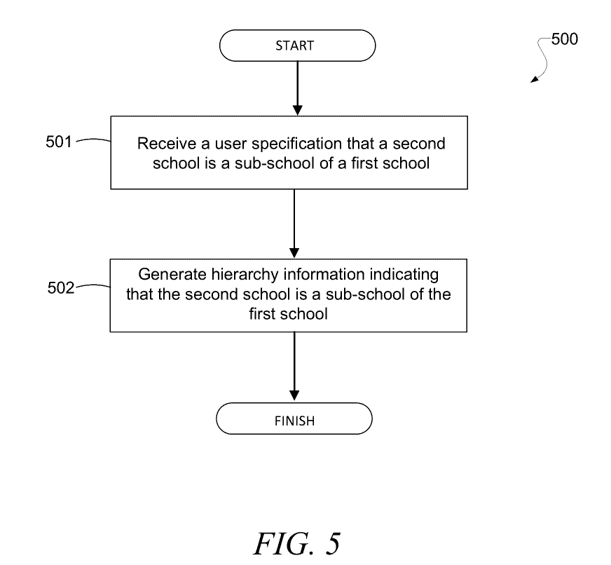

FIG. 5 is a flowchart illustrating an example method 500 for generating or modifying hierarchy information, consistent with various embodiments described herein. The method 500 may be performed at least in part by, for example, the hierarchy management system 200 illustrated in FIG. 2 (or an apparatus having similar modules, such as one or more client machines or application servers). In operation 501, the hierarchy management module 204 receives, via a user interface displayed to an administrator of a first school, a user specification that a second school is a sub-school of the first school. For example, an administrator of “The University of Michigan” may request to list “The University of Michigan Law School” as a sub-school of “The University of Michigan”. In operation 502, the hierarchy management module 204 generates or modifies hierarchy information based on the user specification received in operation 501, so that the hierarchy information indicates that the second school is a sub-school of the first school. It is contemplated that the operations of method 500 may incorporate any of the other features disclosed herein. Various operations in the method 500 may be omitted or rearranged.

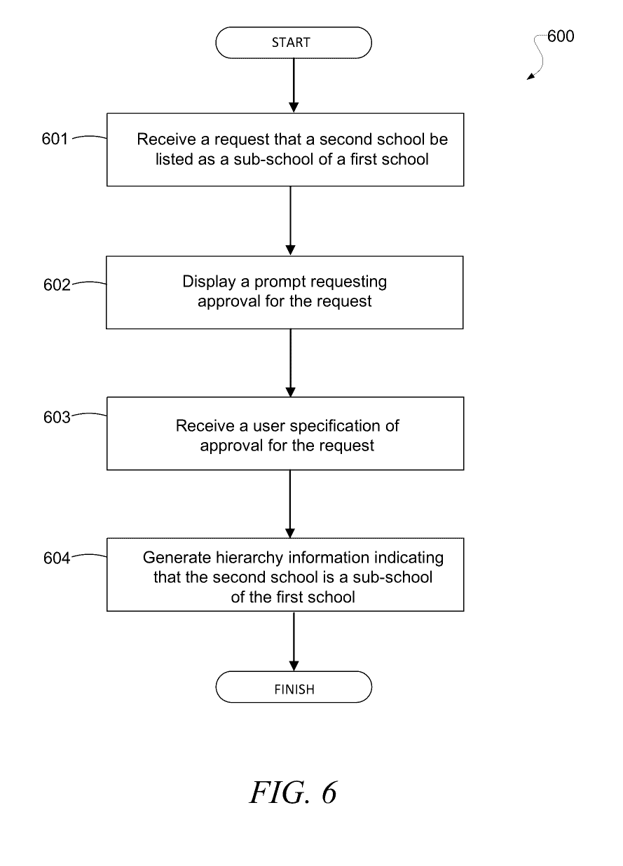

FIG. 6 is a flowchart illustrating an example method 600 for generating or modifying hierarchy information, consistent with various embodiments described herein. The method 600 may be performed at least in part by, for example, the hierarchy management system 200 illustrated in FIG. 2 (or an apparatus having similar modules, such as one or more client machines or application servers). In operation 601, the hierarchy management module 204 receives, via a user interface displayed to an administrator of a second school, a request that the second school be listed as a sub-school of a first school. For example, an administrator of “The University of Michigan Law School” may request to list this school as a sub-school of the parent school “The University of Michigan”. In operation 602, the hierarchy management module 204 displays, via a user interface displayed to an administrator of the first school (specified in the request received in operation 601), a prompt requesting approval for the request that the second school be listed as a sub-school of the first school. In operation 603, the hierarchy management module 204 receives, via the user interface displayed to the administrator of the first school in operation 602, a user specification of approval for the request. In operation 604, the hierarchy management module 204 generates or modifies the hierarchy information, based on the user specification of approval received in operation 603, so that the hierarchy information indicates that the second school is a sub-school of the first school. It is contemplated that the operations of method 600 may incorporate any of the other features disclosed herein. Various operations in the method 600 may be omitted or rearranged.

As described above, a school administrator may request to list a given school as a sub-school of a parent school (e.g., see operation 501 in FIG. 5 or operation 601 in FIG. 6). Thus, this information from the administrator indicates that a school B is a sub-school of a school A (or, put another way, that school A is a parent of school B), and in some embodiments, this information may be utilized as a positive example for training or refining a machine learned model (e.g., as described above in connection with FIG. 3).

In some embodiments, if the system 200 determines that a school B is a sub-school of a school A (e.g., see operation 303 in FIG. 3), the system 200 may display a suggestion to an administrator (e.g., in connection with operation 501 in FIG. 5 or operation 601 in FIG. 6) to confirm this determination. For example, the 200 may display a prompt with the message “it looks like “The University of Michigan Law School” as a sub-school of the “University of Michigan”, is that correct?”. Depending on whether the administrator's response is “Yes or “No”, the response to the prompt may be used as positive examples or negative examples, respectively, for training or refining a machine learned model (e.g., as described above in connection with FIG. 3).

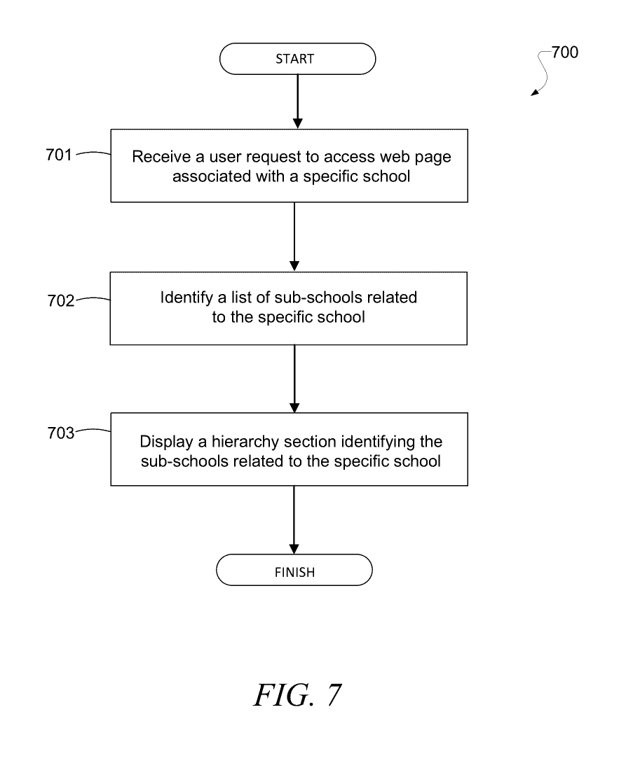

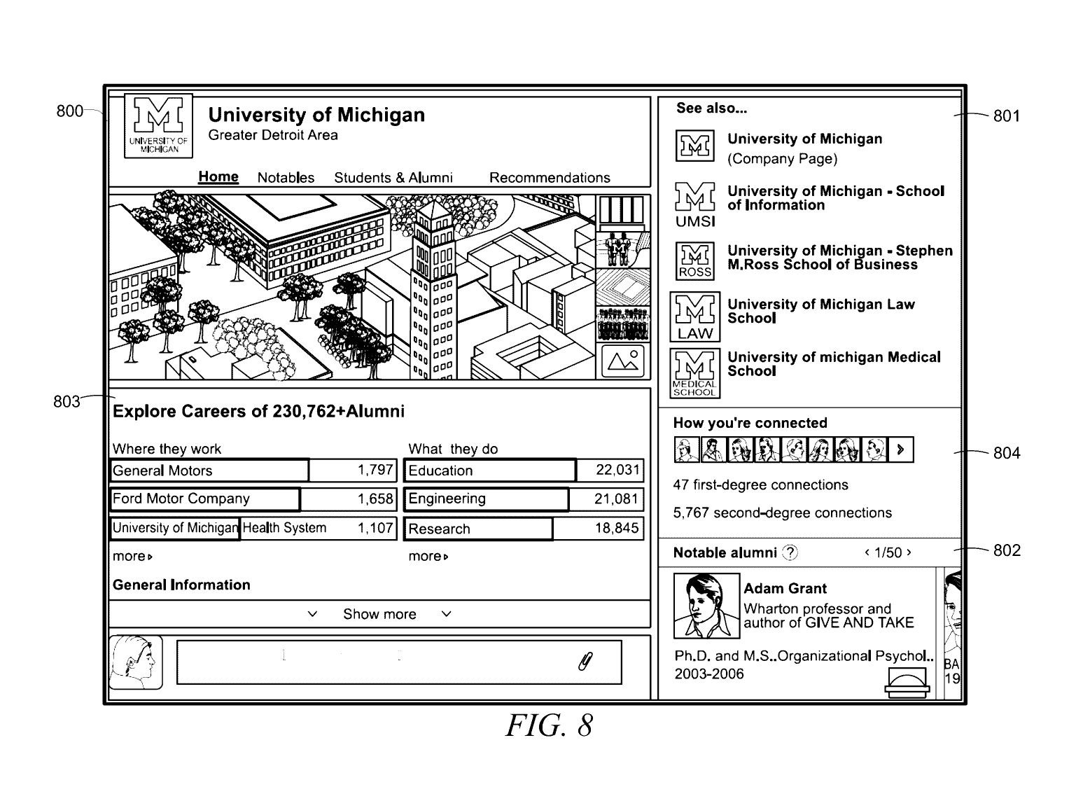

FIG. 7 is a flowchart illustrating an example method 700 for displaying hierarchy information on a school-related webpage, consistent with various embodiments described herein. The method 700 may be performed at least in part by, for example, the hierarchy management system 200 illustrated in FIG. 2 (or an apparatus having similar modules, such as one or more client machines or application servers). In operation 701, the hierarchy management module 204 receives a user request to access a web page associated with a specific school. In operation 702, the hierarchy management module 204 identifies, based on hierarchy information (e.g., as generated in methods 300, 500 or 600), a list of sub-schools related to the specific school specified in operation 701. In operation 703, the hierarchy management module 204 displays the web page associated with the specific school specified in operation 701, the web page including a hierarchy section identifying the sub-schools identified in operation 702 that are related to the specific school. An example of such a webpage 800 is illustrated in FIG. 8, where the webpage 800 includes the aforementioned hierarchy section 801 in the top right portion of FIG. 8. It is contemplated that the operations of method 700 may incorporate any of the other features disclosed herein. Various operations in the method 700 may be omitted or rearranged.

In some embodiments, the hierarchy management module 204 may identify one or more members of the online social networking service corresponding to alumni of sub-schools of a specific school displayed in a webpage. The hierarchy management module 204 may then modify an alumni count associated with the specific school that is displayed on the web page, to include the identified members. Instead, or in addition, the hierarchy management module 204 may list (or display profile pictures of) one or more of the identified members in an alumni section of the webpage that is associated with the specific school (see portion 802 of webpage 800 in FIG. 8). Thus, the alumni counts and the identified alumni for a parent school will include alumni of the appropriate sub-schools of the parent school.

In some embodiments, the hierarchy management module 204 may identify members of the online social networking service corresponding to alumni of sub-schools of a specific school displayed in a webpage and that are also associated with a specific member profile attribute (e.g., alumni having a given location, company, skill, job title, degree, industry, etc.). The hierarchy management module 204 may then modify an alumni count displayed on the web page that is associated with the specific school and the specific member profile attribute, to include the identified members. For example, the portion 803 of webpage 800 in FIG. 8 displays information about alumni of a parent school that work at given companies, work in given industries, etc., and the hierarchy management module 204 will include alumni from the appropriate sub-schools in these alumni counts. Instead, or in addition, the hierarchy management module 204 may list (or display profile pictures of) one or more of the identified members in an alumni section of the webpage that is associated with the specific school. In some embodiments, the aforementioned member profile attribute is any of location, role, industry, language, current job, employer, experience, skills, education, school, endorsements, seniority level, company size, connections, connection count, account level, name, username, social media handle, email address, phone number, fax number, resume information, title, activities, group membership, images, photos, preferences, news, status, links or URLs on a profile page, and so forth.

In some embodiments, the hierarchy management module 204 may identify one or more members of the online social networking service corresponding to alumni of sub-schools of a specific school displayed in a webpage that are also connections of a viewing member (see the portion 804 of webpage 800 in FIG. 8). The hierarchy management module 204 may then modify a connection count associated with the specific school that is displayed on the web page, to include the identified members (e.g., see “47 first-degree connections” in portion 804 of webpage 800 in FIG. 8). Instead, or in addition, the hierarchy management module 204 may list (or display profile pictures of) one or more of the identified members in a connection section of the webpage that is associated with the specific school (see the portion 804 of webpage 800 in FIG. 8). Thus, the alumni-connection counts and the identified alumni-connections for a parent school will include alumni-connections of the appropriate sub-schools of the parent school.

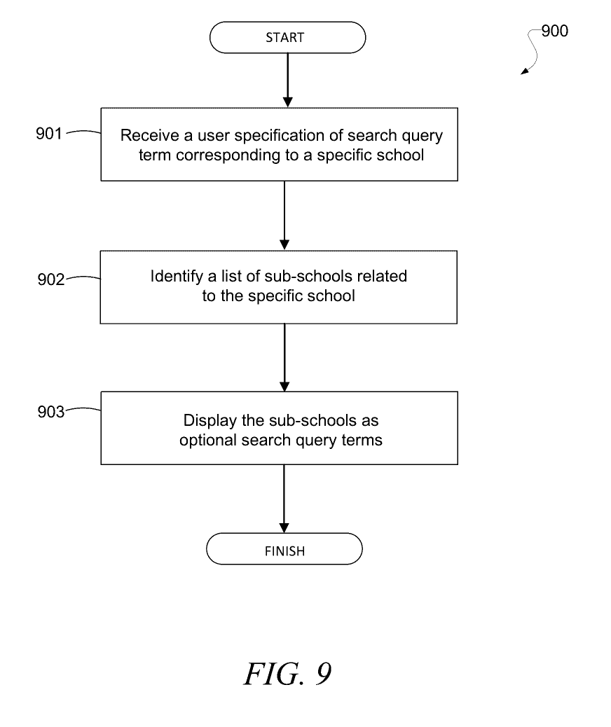

FIG. 9 is a flowchart illustrating an example method 900 for assisting a user in searching for schools, consistent with various embodiments described herein. The method 900 may be performed at least in part by, for example, the hierarchy management system 200 illustrated in FIG. 2 (or an apparatus having similar modules, such as one or more client machines or application servers). In operation 901, the hierarchy management module 204 receives a user specification of search query term corresponding to a specific school (e.g., the user may type in “University of Michigan” in a search query user interface element). In operation 902, the hierarchy management module 204 identifies, based on hierarchy information (e.g., as generated in methods 300, 500 or 600), a list of sub-schools related to the specific school specified in operation 901. In operation 903, the hierarchy management module 204 displays, via a user interface, the sub-schools identified in operation 902 as optional search query terms (e.g., such that, if the user clicks on one of the identified sub-schools, that sub-school is applied as a search query term for the search). It is contemplated that the operations of method 900 may incorporate any of the other features disclosed herein. Various operations in the method 900 may be omitted or rearranged.

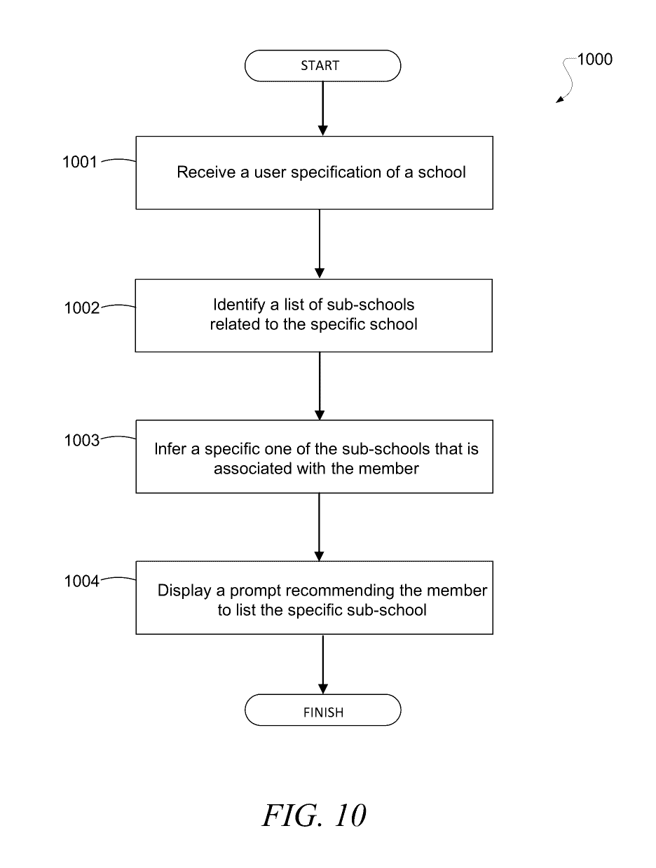

FIG. 10 is a flowchart illustrating an example method 1000 for assisting a user in adding a school to their member profile page, consistent with various embodiments described herein. The method 1000 may be performed at least in part by, for example, the hierarchy management system 200 illustrated in FIG. 2 (or an apparatus having similar modules, such as one or more client machines or application servers). In operation 1001, the hierarchy management module 204 receives a user specification of a school in connection with a request to list the school on a member profile page of a member (e.g., the user may type in “University of Michigan” in a user interface element configured add the school to the user's member profile page). In operation 1002, the hierarchy management module 204 identifies, based on hierarchy information (e.g., as generated in methods 300, 500 or 600), a list of sub-schools related to the specific school specified in operation 1001. In operation 1003, the hierarchy management module 204 infers, based on member profile data of the member, a specific one of the sub-schools identified in operation 1002 that is associated with the member. For example, the hierarchy management module 204 may apply any techniques described in pending U.S. patent application Ser. No. 14/292,779, filed on May 30, 2014, which is incorporated herein by reference, to only the set of sub-schools identified in operation 1002, in order to infer which sub-school in this set the user is most likely associated with (e.g., which sub-school the user attends or previously attended). In operation 1004, the hierarchy management module 204 displays, via a user interface, a prompt recommending the member to list the specific sub-school inferred in operation 1003 on their member profile page. It is contemplated that the operations of method 1000 may incorporate any of the other features disclosed herein. Various operations in the method 1000 may be omitted or rearranged.

Various embodiments herein refer to “schools”, but the embodiments and techniques described herein are applicable to any educational institutions including schools, colleges, training centers, universities, and so on. Moreover, while various embodiments herein are performed based on schools, the techniques described herein may similarly be applied to companies or organizations, such as in cases where company A is a parent of company B (or, put another way, company B is a sub-company, affiliate, subsidiary, etc., of company A).

### Example Prediction Models

As described above, the determination module 202 may use any one of various known prediction modeling techniques to perform the prediction modeling. For example, according to various exemplary embodiments, the determination module 202 may apply a statistics-based machine learning model such as a logistic regression model to the school feature data of school A and school B. As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event given a set of independent/predictor variables. A highly simplified example machine learning model using logistic regression may be ln[p/(1−p)]=a+BX+e, or [p/(1−p)]=exp(a+BX+e), where ln is the natural logarithm, logₑₓₚ, where exp=2.71828 . . . , p is the probability that the event Y occurs, p(Y=1), p/(1−p) is the “odds ratio”, ln[p/(1−p)] is the log odds ratio, or “logit”, a is the coefficient on the constant term, B is the regression coefficient(s) on the independent/predictor variable(s), X is the independent/predictor variable(s), and e is the error term. In some embodiments, the independent/predictor variables of the logistic regression model may correspond to school feature data of school A and school B (where the aforementioned school feature data of school A and school B may be encoded into numerical values and inserted into feature vectors). The regression coefficients may be estimated using maximum likelihood or learned through a supervised learning technique from the recruiting intent signature data, as described in more detail below. Accordingly, once the appropriate regression coefficients (e.g., B) are determined, the features included in a feature vector (e.g., school feature data of school A and school B) may be applied to the logistic regression model in order to predict the probability (or “confidence score”) that the event Y occurs (where the event Y may be, for example, that school A is a parent of school B). In other words, provided a feature vector including various school feature data of school A and school B, the feature vector may be applied to a logistic regression model to determine the probability that school A is a parent of school B. Logistic regression is well understood by those skilled in the art, and will not be described in further detail herein, in order to avoid occluding various aspects of this disclosure. The determination module 202 may use various other prediction modeling techniques understood by those skilled in the art to generate the aforementioned confidence score. For example, other prediction modeling techniques may include other computer-based machine learning models such as a gradient-boosted machine (GBM) model, a Naïve Bayes model, a support vector machines (SVM) model, a decision trees model, and a neural network model, all of which are understood by those skilled in the art.

According to various embodiments described above, the feature data may be used for the purposes of both off-line training (for generating, training, and refining a prediction model and or the coefficients of a prediction model) and online inferences (for generating confidence scores). For example, if the determination module 202 is utilizing a logistic regression model (as described above), then the regression coefficients of the logistic regression model may be learned through a supervised learning technique from the feature data. Accordingly, in one embodiment, the hierarchy management system 200 may operate in an off-line training mode by assembling the school feature data into feature vectors. The feature vectors may then be passed to the determination module 202, in order to refine regression coefficients for the logistic regression model. For example, statistical learning based on the Alternating Direction Method of Multipliers technique may be utilized for this task. Thereafter, once the regression coefficients are determined, the hierarchy management system 200 may operate to perform online (or offline) inferences based on the trained model (including the trained model coefficients) on a feature vector representing the school feature data of school A and school B. According to various exemplary embodiments, the off-line process of training the prediction model (e.g., based on positive training data corresponding to school feature data of schools known to be related, and based on negative training data corresponding to school feature data of schools known not to be related) may be performed periodically at regular time intervals (e.g., once a day), or may be performed at irregular time intervals, random time intervals, continuously, etc. Thus, since school feature data may change over time, it is understood that the prediction model itself may change over time (based on the school feature data used to train the model).

### Example Mobile Device

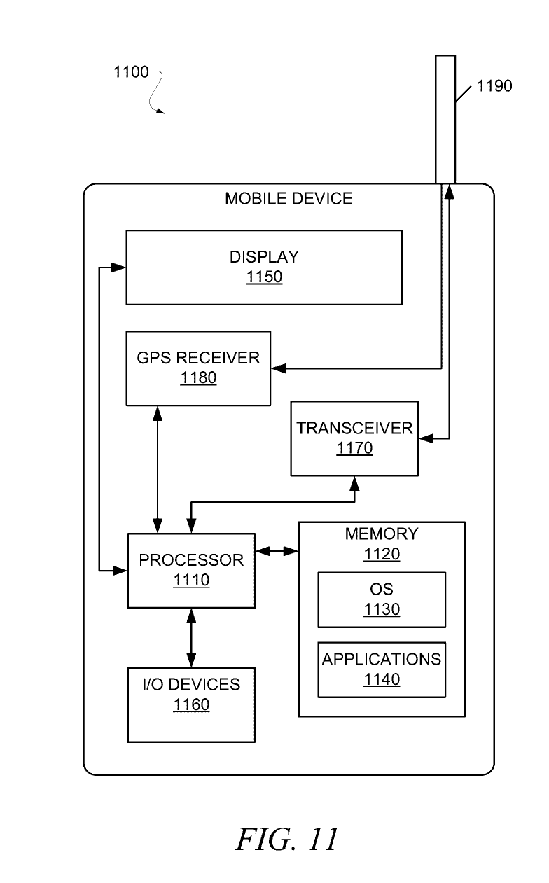

FIG. 11 is a block diagram illustrating the mobile device 1100, according to an example embodiment. The mobile device may correspond to, for example, one or more client machines or application servers. One or more of the modules of the system 200 illustrated in FIG. 2 may be implemented on or executed by the mobile device 1100. The mobile device 1100 may include a processor 1110. The processor 1110 may be any of a variety of different types of commercially available processors suitable for mobile devices (for example, an XScale architecture microprocessor, a Microprocessor without Interlocked Pipeline Stages (MIPS) architecture processor, or another type of processor). A memory 1120, such as a Random Access Memory (RAM), a Flash memory, or other type of memory, is typically accessible to the processor 1110. The memory 1120 may be adapted to store an operating system (OS) 1130, as well as application programs 1140, such as a mobile location enabled application that may provide location based services to a user. The processor 1110 may be coupled, either directly or via appropriate intermediary hardware, to a display 1150 and to one or more input/output (I/O) devices 1160, such as a keypad, a touch panel sensor, a microphone, and the like. Similarly, in some embodiments, the processor 1110 may be coupled to a transceiver 1170 that interfaces with an antenna 1190. The transceiver 1170 may be configured to both transmit and receive cellular network signals, wireless data signals, or other types of signals via the antenna 1190, depending on the nature of the mobile device 1100. Further, in some configurations, a GPS receiver 1180 may also make use of the antenna 1190 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

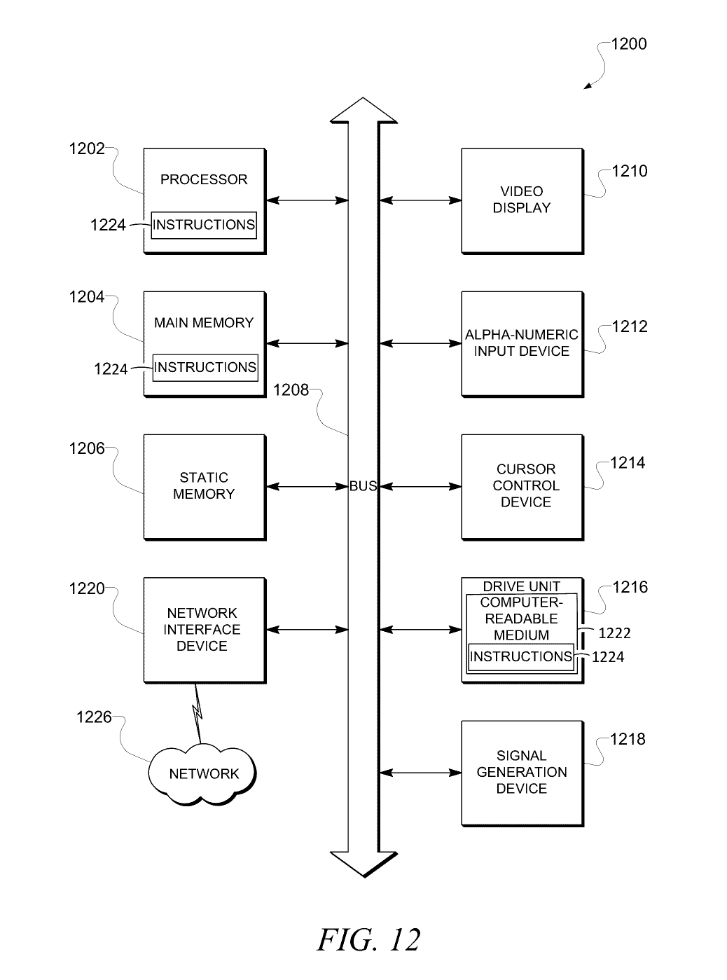

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
accessing, via one or more databases, first feature data describing a first school and second feature data describing a second school;
generating a confidence score indicating a probability that the second school is a sub-school of the first school using a machine learned model, the first feature data and the second feature data being inputs to the machine learned model;
determining, based on a comparison of the confidence score to a threshold, that the second school is a sub-school of the first school; and
generating hierarchy information identifying a hierarchy of relationships between a plurality of schools, the hierarchy information indicating that the second school is a sub-school of the first school.

2. The method of claim 1, wherein the first feature data and the second feature data describe a name, uniform resource locator (URL), and location of the first school and the second school, respectively.

3. The method of claim 1, further comprising:
receiving, via a user interface displayed to an administrator of a third school, a user specification that a fourth school is a sub-school of the third school; and
generating the hierarchy information based on the user specification, the hierarchy information indicating that the fourth school is a sub-school of the third school.

4. The method of claim 1, further comprising:
receiving, via a user interface displayed to an administrator of a fourth school, a request that the fourth school be listed as a sub-school of a third school;
displaying, via a user interface displayed to an administrator of the third school, a prompt requesting approval for the request;
receiving, via the user interface displayed to the administrator of the third school, a user specification of approval for the request; and
generating the hierarchy information based on the user specification of approval, the hierarchy information indicating that the fourth school is a sub-school of the third school.

5. The method of claim 1, further comprising:
receiving a user request to access a web page associated with a specific school;
identifying, based on the hierarchy information, a list of sub-schools related to the specific school; and
displaying the web page associated with the specific school, the web page including a hierarchy section identifying the sub-schools related to the specific school.

6. The method of claim 5, further comprising:
identifying one or more members of the online social networking service corresponding to alumni of one or more of the sub-schools; and
modifying an alumni count associated with the specific school that is displayed on the web page, the modified alumni count including the identified members.

7. The method of claim 6, further comprising:
listing one or more of the identified members in an alumni section of the webpage that is associated with the specific school.

8. The method of claim 5, further comprising:
identifying one or more members of the online social networking service corresponding to alumni of one or more of the sub-schools and that are further associated with a specific member profile attribute, the specific member profile attribute corresponding to location, company, skill, job title, degree, or industry; and
modifying an alumni count displayed on the web page that is associated with the specific school and the specific member profile attribute, the modified alumni count including the identified members.

9. The method of claim 5, further comprising:
identifying one or more members of the online social networking service corresponding to alumni of one or more of the sub-schools that are connections of a viewing member; and
modifying a connection count associated with the specific school that is displayed on the web page, the connection count including the identified members.

10. The method of claim 9, further comprising:
listing one or more of the identified members in a connection section of the webpage that is associated with the specific school.

11. The method of claim 1, further comprising:
receiving a user specification of search query term corresponding to a specific school;
identifying, based on the hierarchy information, a list of sub-schools related to the specific school; and
displaying, via a user interface, the sub-schools as optional search query terms.

12. The method of claim 1, further comprising:
receiving a user specification of a school in connection with a request to list the school on a member profile page of a member of an online social networking service;
identifying, based on the hierarchy information, a list of sub-schools related to the specific school;
inferring, based on member profile data of the member, a specific one of the sub-schools that is associated with the member; and
displaying, via a user interface, a prompt recommending the member to list the specific sub-school on their member profile page.

13. A computer system comprising:
a processor;
a memory device holding an instruction set executable on the processor to cause the computer system to perform operations comprising:
accessing, via one or more databases, first feature data describing a first school and second feature data describing a second school;
generating a confidence score indicating a probability that the second school is a sub-school of the first school using a machine learned model, the first feature data and the second feature data being inputs to the machine learned model;
determining, based on a comparison of the confidence score to a threshold, that the second school is a sub-school of the first school; and
generating hierarchy information identifying a hierarchy of relationships between a plurality of schools, the hierarchy information indicating that the second school is a sub-school of the first school.

14. The system of claim 13, further comprising:
receiving, via a user interface displayed to an administrator of a third school, a user specification that a fourth school is a sub-school of the third school; and
generating the hierarchy information, based on the user specification, the hierarchy information indicating that the fourth school is a sub-school of the third school.

15. The system of claim 13, further comprising:
receiving, via a user interface displayed to an administrator of a fourth school, a request that the fourth school be listed as a sub-school of a third school;
displaying, via a user interface displayed to an administrator of the third school, a prompt requesting approval for the request;
receiving, via the user interface displayed to the administrator of the third school, a user specification of approval for the request; and
generating the hierarchy information, based on the user specification of approval, the hierarchy information indicating that the fourth school is a sub-school of the third school.

16. The system of claim 13, further comprising:
receiving a user request to access a web page associated with a specific school;
identifying, based on the hierarchy information, a list of sub-schools related to the specific school; and
displaying the web page associated with the specific school, the web page including a hierarchy section identifying the sub-schools related to the specific school.

17. The system of claim 16, further comprising:
identifying one or more members of the online social networking service corresponding to alumni of one or more of the sub-schools; and
modifying an alumni count associated with the specific school that is displayed on the web page, the modified alumni count including the identified members.

18. The system of claim 16, further comprising:
identifying one or more members of the online social networking service corresponding to alumni of one or more of the sub-schools and that are further associated with a specific member profile attribute, the specific member profile attribute corresponding to location, company, skill, job title, degree, or industry; and
modifying an alumni count displayed on the web page that is associated with the specific school and the specific member profile attribute, the modified alumni count including the identified members.

19. The system of claim 16, further comprising:
identifying one or more members of the online social networking service corresponding to alumni of one or more of the sub-schools that are connections of a viewing member; and
modifying a connection count associated with the specific school that is displayed on the web page, the connection count including the identified members.

20. A non-transitory machine-readable storage medium comprising instructions that, when executed by one or more processors of a machine, cause the machine to perform operations comprising:
accessing, via one or more databases, first feature data describing a first school and second feature data describing a second school;
generating a confidence score indicating a probability that the second school is a sub-school of the first school using a machine learned model, the first feature data and the second feature data being inputs to the machine learned model;
determining, based on a comparison of the confidence score to a threshold, that the second school is a sub-school of the first school; and
generating hierarchy information identifying a hierarchy of relationships between a plurality of schools, the hierarchy information indicating that the second school is a sub-school of the first school.
